(19) United States
(12) Patent Application Publication
(10) Pub. No.: US 2016/0075545 A1
(43) Pub. Date: Mar. 17, 2016

(54) Magnetic Bottle Cap Catcher and Methods of Using the Same

(71) Applicant: Mason Bishop, Lake in the Hills, IL (US)

(72) Inventor: Mason Bishop, Lake in the Hills, IL (US)

(21) Appl. No.: 14/853,518

(22) Filed: Sep. 14, 2015

Related U.S. Application Data
(60) Provisional application No. 62/049,715, filed on Sep. 12, 2014.

(51) Int. Cl. B67B 7/16

(52) U.S. Cl. CPC B67B 7/16

(57) ABSTRACT

The present invention relates to a magnetic bottle cap catcher and methods of using the same. Specifically, the present invention relates to a magnetic portion adjacent a bottle opener that catches opened bottle caps. Even more specifically, the present invention relates to a plurality of embodiments that ensure that a bottle cap is magnetically caught when using the bottle opener no matter which angle the bottle opener is used.

The present invention claims priority to U.S. Provisional Pat. App. No. 62/049,715, titled “Magnetic Bottle Cap Catcher and Methods of Using the Same,” filed Sep. 12, 2014, which is incorporated herein by reference in its entirety.

### TECHNICAL FIELD

The present invention relates to a magnetic bottle opener. Specifically, the present invention relates to a magnetic portion adjacent a bottle opener that catches opened bottle caps.

### BACKGROUND

It is, of course, generally known to open beverage containers. Beverages need to be contained such that the contents do not spill or become contaminated during transportation and distribution. Beverage containers come in many shapes and forms such as cans, boxes, kegs, pouches, bottles, etc. Each beverage container type often requires a different type of opener. Cans generally have a tab for opening, boxes may be cut open or may have a cap, kegs may be accessed using a tap, pouches may be punctured, and bottles may be opened with a bottle opener.

Bottle openers also come in many shapes and forms. Often, a bottle opener has a lever that is insertable beneath a bottle cap, and a fulcrum that is generally placed somewhere on top or the bottle cap to create a pivot point by which the lever may rotate, bend, and otherwise remove the bottle cap from the bottle.

Bottle openers can be have a vertical orientation, such as with pocket knife bottle openers and churchkeys, but may alternatively have a horizontal orientation, such as with simple bottle or speed openers. Additionally, bottle openers may be mounted onto walls, so that bottles may be opened with a single hand. In all types of bottle openers, once a bottle cap is removed from the bottle, the bottle cap generally falls downwardly away from the bottle opener, often onto the floor, ground, or other location. Not only does this create a littering problem, but it also creates additional work for those that do not wish to litter and whom search to retrieve the bottle cap. A need exists for an apparatus and method of using the same for simplifying and/or eliminating the retrieval process.

Some wall mounted bottle openers have a bin to catch falling caps. Often, this requires a channel or a large bin in order to encompass the range in which bottle caps fall from the mounted bottle opener. Additionally, other wall mounted bottle openers have a magnetic catch disposed a length beneath the wall mounted bottle opener for magnetically catching bottle caps as they fall downwardly from the bottle opener. These require extremely powerful or large magnets to create a magnetic field large enough to encompass the range in which bottle caps fall from the mounted bottle opener. A need exist for an apparatus and method for catching bottle caps that doesn't require a channel, large bin, and/or extremely powerful or large magnets.

Additionally, users of the above mentioned bottle openers commonly fail to retrieve and to dispose of the bottle caps because the bottle opener retrieves the bottle caps for the user. Therefore, bottle caps pile up and may reduce the effectiveness of the catch (whether it is a bin or a magnet), and must be regularly maintained and/or emptied in order to continue efficient use. A need exists for an apparatus and method for opening bottles and catching bottle caps that eliminates the pile up problem.

### SUMMARY OF THE INVENTION

The present invention relates to a magnetic bottle cap catcher and methods of using the same. Specifically, the present invention relates to a magnetic portion adjacent a bottle opener that catches opened bottle caps. Even more specifically, the present invention relates to a plurality of embodiments that ensure that a bottle cap is magnetically caught when using the bottle opener no matter which angle the bottle opener is used.

To this end, in an embodiment of the present invention, an apparatus is provided. The apparatus comprises a solid material with a bottle opener disposed on one end and a magnetic portion disposed adjacent the bottle opener.

In an alternate embodiment of the present invention, a method is provided. The method comprises the steps of providing an apparatus with a bottle opener disposed on one end and a magnetic portion disposed adjacent the bottle opener, providing a bottle with a bottle cap, opening the bottle cap with the bottle opener, wherein the magnetic portion disposed adjacent the bottle opener prevents the bottle cap from leaving the apparatus, and disposing of the bottle cap.

It is, therefore, an advantage and objective of the present invention to provide an apparatus and method of using the same for simplifying and/or eliminating the retrieval process.

It is an advantage and objective of the present invention to provide an apparatus and method for opening bottles and catching bottle caps that doesn't require a channel, large bin, and/or extremely powerful or large magnets.

It is an advantage and objective of the present invention to provide an apparatus and method for opening bottles and catching bottle caps that eliminates the pile up problem.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates a perspective top view of a magnetic bottle cap catcher in an embodiment of the present invention.

FIG. 2 illustrates a perspective bottom view of a magnetic bottle cap catcher in an embodiment of the present invention.

FIG. 3 illustrates a top view of a magnetic bottle cap catcher removing a bottle cap with a lip in an embodiment of the present invention.

FIG. 4 illustrates a bottom view of the magnetic bottle cap catcher in FIG. 3 removing the bottle cap with the lip in an embodiment of the present invention.

FIG. 5 illustrates a bottom view of the magnetic bottle cap catcher in FIGS. 3-4 magnetically catching the bottle cap after removal in an embodiment of the present invention.

FIG. 6 illustrates a top view of a magnetic bottle cap catcher removing a bottle cap with an edge in an alternate embodiment of the present invention.

FIG. 7 illustrates a bottom view of the magnetic bottle cap catcher in FIG. 6 removing the bottle cap with the edge in an alternate embodiment of the present invention.

FIG. 8 illustrates a bottom view of the magnetic bottle cap catcher in FIGS. 6-7 magnetically catching the bottle cap after removal in an alternate embodiment of the present invention.

FIG. 9 illustrates a bottom view of a magnetic bottle cap catcher removing the bottle cap with the lip in an alternate embodiment of the present invention.

FIG. 10 illustrates a bottom view of a magnetic bottle cap catcher removing the bottle cap with the edge in an alternate embodiment of the present invention.

FIG. 11 illustrates a bottom view of the magnetic bottle cap catcher in FIG. 10 magnetically catching the bottle cap after removal in an alternate embodiment of the present invention.

FIG. 12 illustrates a bottom view of a magnetic bottle cap catcher removing the bottle cap with the lip in an alternate embodiment of the present invention.

FIG. 13 illustrates a bottom view of the magnetic bottle cap catcher in FIG. 12 removing the bottle cap with the edge in an alternate embodiment of the present invention.

FIG. 14 illustrates a bottom view of the magnetic bottle cap catcher in FIGS. 12-13 magnetically catching the bottle cap after removal in an alternate embodiment of the present invention.

FIG. 15 illustrates a bottom view of a magnetic bottle cap catcher removing the bottle cap with the lip in an alternate embodiment of the present invention.

FIG. 16 illustrates a bottom view of the magnetic bottle cap catcher in FIG. 15 removing the bottle cap with the edge in an alternate embodiment of the present invention.

FIG. 17 illustrates a bottom view of the magnetic bottle cap catcher in FIGS. 15-16 magnetically catching the bottle cap after removal in an alternate embodiment of the present invention.

### DETAILED DESCRIPTION OF THE PRESENTLY PREFERRED EMBODIMENTS

The present invention relates to a magnetic bottle cap catcher and methods of using the same. Specifically, the present invention relates to a magnetic portion adjacent a bottle opener that catches opened bottle caps. Even more specifically, the present invention relates to a plurality of embodiments that ensure that a bottle cap is magnetically caught when using the bottle opener no matter which angle the bottle opener is used.

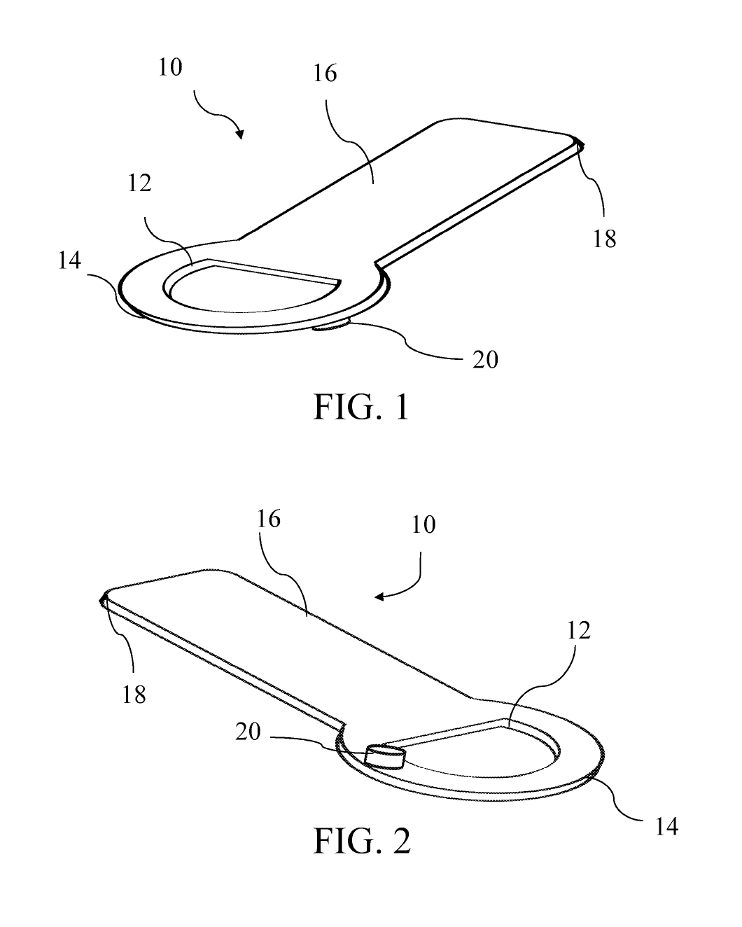

Now referring to the figures, wherein like numerals refer to like parts, FIG. 1 illustrates, a bottle cap catcher 10. The bottle cap catcher 10 may comprise a bottle opener 12 on a first end 14 and a handle 16 on a second end 18. The handle 16 may be used as a lever in order to remove bottle caps from bottles using the bottle opener 12 on the first end 14. The bottle cap catcher 10 may be made of a solid material such as metal, plastic, fiberglass, polymer, rock, wood, or other solid material known to one skilled in the art. In one embodiment, the bottle cap catcher 10 may be completely magnetic, such as being a permanent magnet. Alternatively, the bottle cap catcher 10 may be made of a ferromagnetic material, which may become magnetic by applying a magnetic field. In another embodiment, just the first end 14 and/or the bottle opener 12 may be magnetic.

In an embodiment, the bottle cap catcher 10 may have a magnet 20 disposed adjacent the bottle opener 12, as shown by FIGS. 1-17. The magnet 20 may be attached to the bottle cap catcher 10 with an adhesive material or may be magnetically attached, where the bottle cap catcher 10 is made of a ferromagnetic material. The magnet 20 may be disposed in numerous locations adjacent the bottle opener 12 and may be any number of shapes, as shown in FIGS. 1-17 and further described below. The magnet 20 may be disposed as shown in FIGS. 1-2, but may be alternatively disposed in other locations. The magnet 20 need only be powerful enough to attract and catch a single bottle cap, and therefore need not be extremely powerful and/or large. Of course, the magnet 20 may be large and/or extremely powerful in some embodiments.

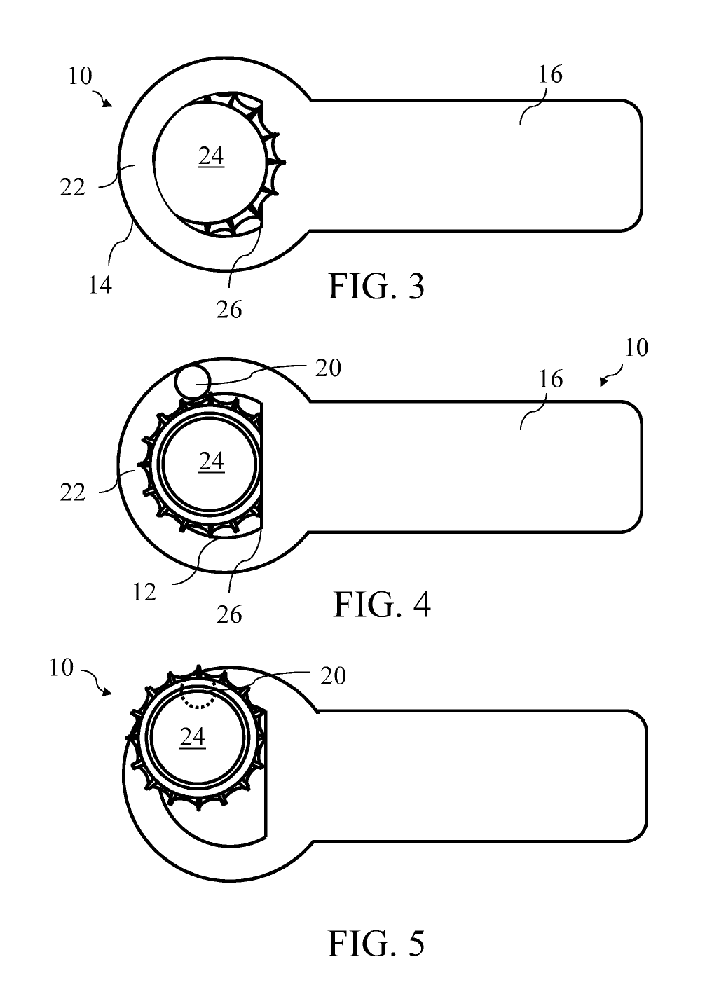

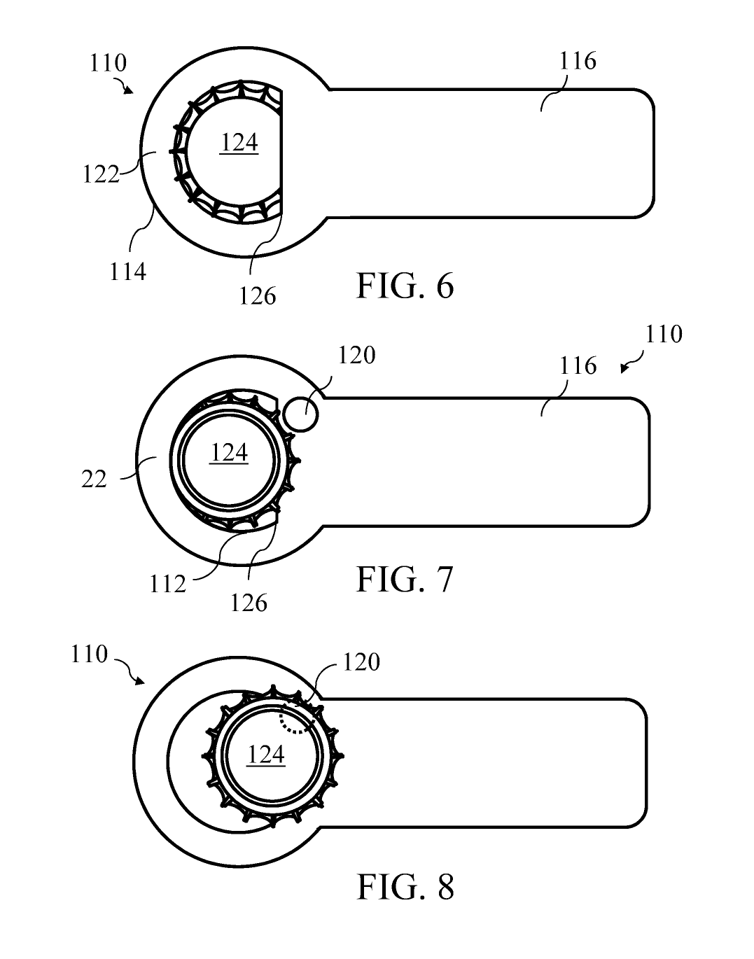

As shown in FIGS. 3 and 6, the bottle cap catcher 10 may be used in multiple orientations. In a first orientation, shown at least in FIG. 3, an edge 22 on the first end 14 may be placed on a top of a bottle cap 24, when in use. Additionally, a lip 26 may be placed beneath a first side of the bottle cap 24. In the first orientation, the handle 16 may be pulled upwardly such that the lip 26 presses against the first side of the bottle cap 24 and the edge 22 presses downwardly on the top of the bottle cap 24. In the first orientation, the edge 22 acts as a fulcrum, about which the handle 16 may rotate and lift the first side of the bottle cap 24, thereby releasing the bottle cap 24 from a bottle (not shown).

FIG. 4 illustrates a bottom view of the first orientation, further showing the magnet 20 disposed adjacent the bottle opener 12 and adjacent the bottle cap 24, when in use. In one embodiment, the magnet 20 may be disposed adjacent the edge 22 on a bottom side of the bottle cap catcher 10. Preferably, the magnet 20 may be as close to the bottle cap 24 as possible without interfering with the removal of the bottle cap 24 from a bottle. Of course, the magnet 20 may be placed anywhere adjacent the bottle opener 12 that may allow the bottle cap 24 to be caught as described herein.

Once the bottle cap 24 is released from the bottle, the bottle cap 24 may be magnetically attracted to the magnet 20 and may be magnetically caught by the magnet 20, as shown in FIG. 5. The bottle cap 24 may remain magnetically caught by the magnet 20 until a user or other person removes the bottle cap 24. The bottle cap 24 may be removed at the leisure of the user or other person and may be properly disposed of without having to bend over to find, pick up, or otherwise locate the bottle cap 24.

In a second orientation, shown at least in FIG. 6, an edge 122 on a first end 114 of a bottle cap catcher 110 may be placed beneath a second side of a bottle cap 124. Additionally, a lip 126 may be placed on a top of the bottle cap 124. In the second orientation, a handle 116 may be pushed downwardly such that the lip 126 presses downwardly on the top of the bottle cap 124 and the edge 122 presses up against the second side of the bottle cap 124. In the second orientation, the lip 126 acts as a fulcrum, about which the handle 116 may rotate and lift the second side of the bottle cap 124, thereby releasing the bottle cap 124 from a bottle (not shown).

FIG. 7 illustrates a bottom view of the second orientation, further showing a magnet 120 disposed adjacent a bottle opener 112 and adjacent the bottle cap 124, when in use. In one embodiment, the magnet 120 may be disposed adjacent the lip 126 on a bottom side of the bottle cap catcher 110. Preferably, the magnet 120 may be as close to the bottle cap 124 as possible without interfering with the removal of the bottle cap 124 from a bottle. Of course, the magnet 120 may be placed anywhere adjacent the bottle opener 112 that may allow the bottle cap 124 to be caught as described herein.

Once the bottle cap 124 is released from the bottle, the bottle cap 124 may be magnetically attracted to the magnet 120 and may be magnetically caught by the magnet 120, as shown in FIG. 8. The bottle cap 124 may remain magnetically caught by the magnet 120 until a user or other person removes the bottle cap 124. The bottle cap 124 may be removed at the leisure of the user or other person and may be properly disposed of without having to bend over to find, pick up, or otherwise locate the bottle cap 124.

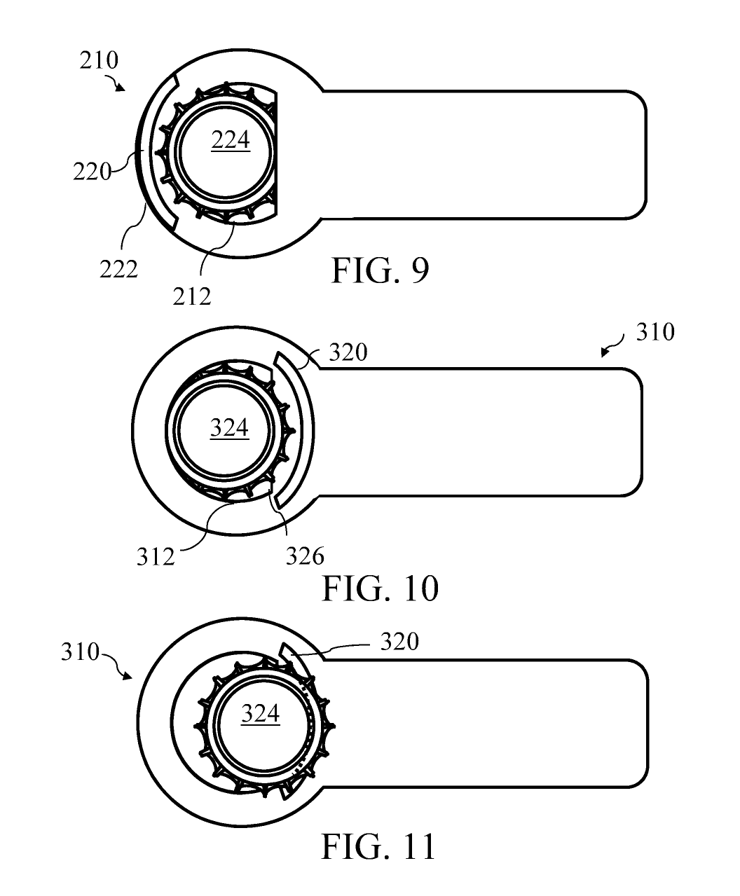

FIG. 9 illustrates a bottom view of a first orientation of an alternate embodiment a bottle cap catcher 210. The bottle cap catcher 210 may have a magnet 220 disposed adjacent a bottle opener 212 and adjacent a bottle cap 224, when in use. In one embodiment, the magnet 220 may be disposed adjacent an edge 222 on a bottom side of the bottle cap catcher 210. Preferably, the magnet 220 may be as close to the bottle cap 224 as possible without interfering with the removal of the bottle cap 224. Of course, the magnet 220 may be placed anywhere adjacent the bottle opener 212 that may allow the bottle cap 224 to be caught as described herein.

FIG. 10 illustrates a bottom view of a second orientation of an alternate embodiment a bottle cap catcher 310. The bottle cap catcher 310 may have a magnet 320 disposed adjacent a bottle opener 312 and a bottle cap 324. In one embodiment, the magnet 320 may be disposed adjacent a lip 326 on a bottom side of the bottle cap catcher 310. Preferably, the magnet 320 may be as close to the bottle cap 324 as possible without interfering with the removal of the bottle cap 324 from a bottle. Of course, the magnet 320 may be placed anywhere adjacent the bottle opener 312 that may allow the bottle cap 324 to be caught as described herein.

Once the bottle cap 324 is released from the bottle, the bottle cap 324 may be magnetically attracted to the magnet 320 and may be magnetically caught by the magnet 320, as shown in FIG. 11. The bottle cap 324 may remain magnetically caught by the magnet 320 until a user or other person removes the bottle cap 324. The bottle cap 324 may be removed at the leisure of the user or other person and may be properly disposed of without having to bend over to find, pick up, or otherwise locate the bottle cap 324.

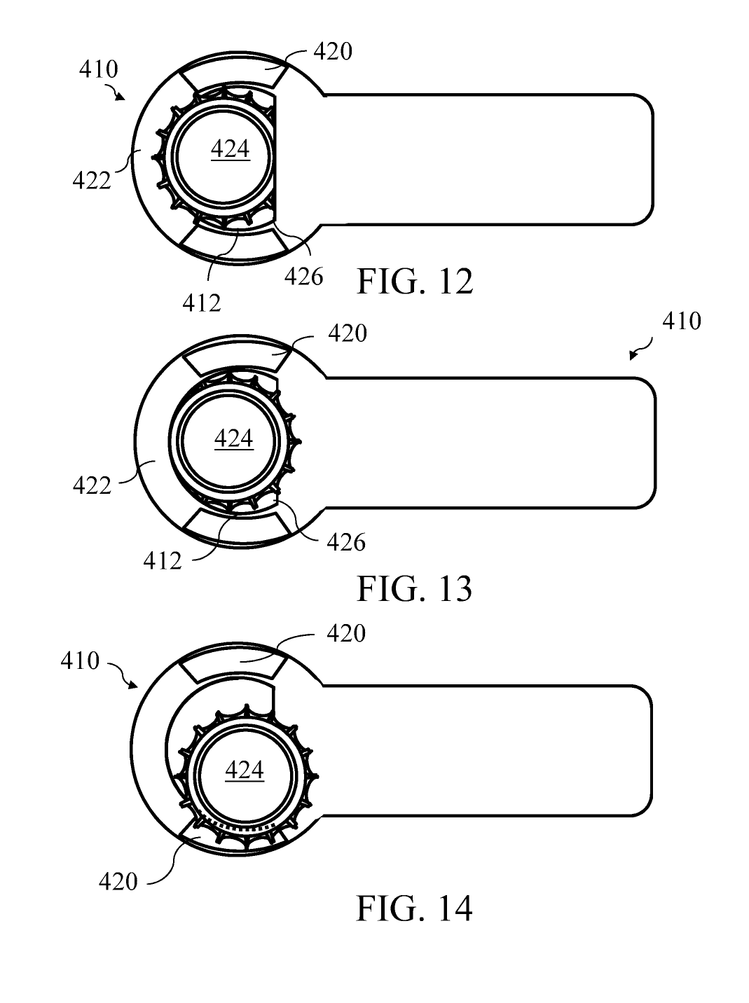

FIGS. 12-14 illustrate a bottom view of a bottle cap catcher 410, wherein magnet placement does not need to change depending on the orientation. FIG. 12 illustrates a first orientation of the bottle cap catcher 410 and FIG. 13 illustrates a second orientation of the bottle cap catcher 410. The bottle cap catcher 410 may have a plurality of magnets 420 disposed on a plurality of sides of a bottle opener 412 and adjacent a bottle cap 424. In one embodiment, the plurality of magnets 420 may be disposed between an edge 422 and a lip 426 on a bottom side of the bottle cap catcher 410. Preferably, the plurality of magnets 420 may be as close to the bottle cap 424 as possible without interfering with the removal of the bottle cap 424 from a bottle. Of course, the plurality of magnets 420 may be placed anywhere adjacent the bottle opener 412, such as having one of the plurality of magnets 420 disposed near the edge 422 and one of the plurality of magnets 420 disposed near the lip 426, which may also allow the bottle cap 424 to be caught as described herein.

Once the bottle cap 424 is released from the bottle, the bottle cap 424 may be magnetically attracted to one of the plurality of magnets 420 and may be magnetically caught by one of the plurality of magnets 420, as shown in FIG. 14. The bottle cap 424 may remain magnetically caught by one of the plurality of magnets 420 until a user or other person removes the bottle cap 424. The bottle cap 424 may be removed at the leisure of the user or other person and may be properly disposed of without having to bend over to find, pick up, or otherwise locate the bottle cap 424. In this embodiment, the bottle cap catcher 410 may be used to release bottle caps 424 from bottles in a first orientation and a second orientation without reducing the magnetic attraction between the bottle caps 424 and the plurality of magnets 420. The bottle cap 424 may be attracted to any and/or all of the plurality of magnets 420, such that the bottle cap 424 may always be caught by at least one of the plurality of magnets 420.

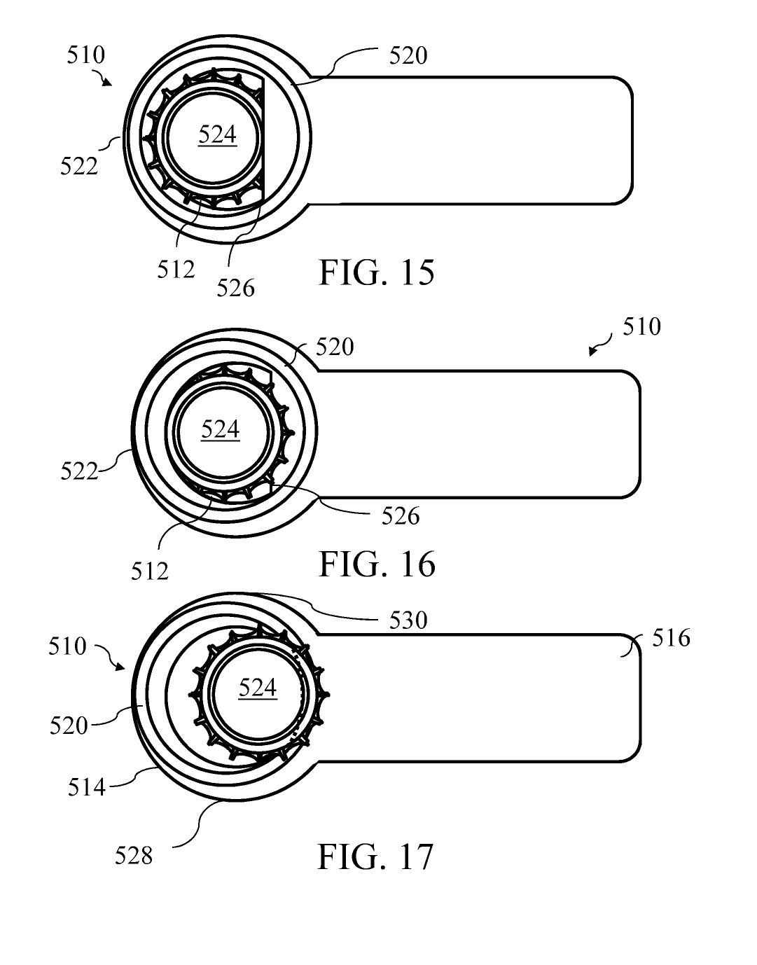

FIGS. 15-17 illustrate a bottom view of a bottle cap catcher 510, wherein magnet placement does not need to change depending on the orientation. FIG. 15 illustrates a first orientation of the bottle cap catcher 510 and FIG. 14 illustrates a second orientation of the bottle cap catcher 510. The bottle cap catcher 510 may have a circular magnet 520 disposed around a bottle opener 512 and adjacent a bottle cap 524. In one embodiment, the circular magnet 520 may be disposed on an edge 522, a lip 526, and therebetween on a bottom side of the bottle cap catcher 510. Preferably, the circular magnet 520 may be as close to the bottle cap 524 as possible without interfering with the removal of the bottle cap 524 from a bottle. Of course, the circular magnet 520 may be placed anywhere adjacent the bottle opener 512 that may allow the bottle cap 524 to be caught as described herein.

Once the bottle cap 524 is released from the bottle, the bottle cap 524 may be magnetically attracted to the circular magnet 520 and may be magnetically caught by the circular magnet 520, as shown in FIG. 17. The bottle cap 524 may remain magnetically caught by the circular magnet 520 until a user or other person removes the bottle cap 524. The bottle cap 524 may be removed at the leisure of the user or other person and may be properly disposed of without having to bend over to find, pick up, or otherwise locate the bottle cap 524. In this embodiment, the bottle cap catcher 510 may be used to release bottle caps 524 from bottles in a first orientation and a second orientation without reducing the magnetic attraction between the bottle caps 524 and the circular magnet 520. The bottle cap 524 may be attracted to any portion of the circular magnet 520, such that the bottle cap 524 may always be caught by the circular magnet 520.

In an alternate embodiment, the bottle cap catcher 510 may use a first side 528 and a second side 530 to remove the bottle cap 524. In one embodiment, the first side 528 may be placed on a top of the bottle cap 524. Additionally, the second side 530 may be placed beneath a side of the bottle cap 524. In this embodiment, a handle 516 may twisted such that the second side 530 presses upwardly against the side of the bottle cap 524 and the first side 528 presses downwardly on the top of the bottle cap 524. Therefore, the first side 528 may act as a fulcrum, about which the handle 516 may rotate and lift the side of the bottle cap 524, thereby releasing the bottle cap 524 from a bottle (not shown).

In another embodiment, the second side 530 may be placed on a top of the bottle cap 524. Additionally, the first side 528 may be placed beneath a side of the bottle cap 524. In this embodiment, a handle 516 may twisted such that the first side 528 presses upwardly against the side of the bottle cap 524 and the second side 530 presses downwardly on the top of the bottle cap 524. Therefore, the second side 530 may act as a fulcrum, about which the handle 516 may rotate and lift the side of the bottle cap 524, thereby releasing the bottle cap 524 from a bottle (not shown). The circular magnet 520 may be disposed around a first end 514 of the bottle cap catcher 510 such that the bottle cap 524 may be removed from the bottle from any angle, such as the front, sides, back, corners, etc.

While the present invention has been shown and described as being implemented using a bottle opener and a lever, the present invention may be implemented in other embodiments. In a plurality of embodiments, the bottle itself may be the lever and the bottle opener may remain static as the bottle rotates. Of course, the bottle opener may be magnetic or may have a magnet disposed adjacent the bottle opener, as described herein, such that bottle caps may be magnetically caught when the bottle cap is released from the bottle. For example, the present invention may be implemented on key chains, hats, sandals, belt buckles, walls, appliances, utility knives, pocket knives, multi-tools, utensils, coolers, grills, can openers, bottle openers, other applications apparent to those skilled in the art, and any combination thereof.

It should be noted that various changes and modifications to the presently preferred embodiments described herein will be apparent to those skilled in the art. Such changes and modifications may be made without departing from the spirit and scope of the present invention and without diminishing its attendant advantages. Further, references throughout the specification to “the invention” are nonlimiting, and it should be noted that claim limitations presented herein are not meant to describe the invention as a whole. Moreover, the invention illustratively disclosed herein suitably may be practiced in the absence of any element which is not specifically disclosed herein.

I claim:

1. An apparatus comprising:
a base material with a bottle opener disposed on one end and a magnetic portion disposed adjacent the bottle opener.

2. A method for opening a bottle with a metal bottle cap, the method comprising the steps of:
providing an apparatus with a bottle opener disposed on one end and a magnetic portion disposed adjacent the bottle opener;
providing a bottle with a bottle cap;
opening the bottle cap with the bottle opener, wherein the magnetic portion disposed adjacent the bottle opener is configured to prevent the bottle cap from leaving the apparatus; and
magnetically holding the bottle cap with the magnetic portion.
